(19) United States
(12) Patent Application Publication
(10) Pub. No.: US 2003/0108190 A1
(43) Pub. Date: Jun. 12, 2003

(54) Line conditioner and build-out for telephone systems

(76) Inventors: Jeffrey Kaiser, Roselle, IL (US); Daniel Ziemba, Carpentersville, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/017,799

(22) Filed: Dec. 12, 2001

(51) Int. Cl. H04M 1/00; H04M 9/00

(52) U.S. Cl. 379/399.01; 379/413.02

(57) ABSTRACT

An improved telephone customer transmission line conditioner, method of making a line conditioner, improved build-out, method of making a build-out, and improved method of conditioning a line using the line conditioner and/or the improved build-out provide improved voice-band transmission as compared to a bare twisted pair, while also allowing the transmission of high-frequency digital signals, such as ADSL signals and other signals. The apparatus and method provide a boost in the high end of the voice-band (approximately 2 kHz to 3.4 kHz) to compensate for the roll-off normally located there in a bare cable, and also provide a substantial rise in the frequency response in a frequency range used for high-frequency digital transmissions. A notch in the response between frequency bands suppresses harmonic cross talk between bands.

### TECHNICAL FIELD

This invention relates generally to communications technologies and, more particularly, relates to techniques for assuring passage of high-quality signals in each of a set of distinct frequency ranges over a conductive communication medium.

### BACKGROUND OF THE INVENTION

Information communication technologies are critical to a great number of endeavors. In general, such endeavors include primarily bidirectional real-time information exchange such as for interpersonal communications or interactive sessions, and unidirectional information transmission or retrieval. For all types of technologies and uses, the Public Switched Telephone Network (PSTN) remains a critical part of many communication links. Although the PSTN was once strictly an analog system, such networks are today primarily digital. However, analog lines still predominate in links between customers and the telephone company's local central office.

Although hard-wired telephone connections are still primarily useful for voice or voice band communications, users increasingly wish to employ the PSTN analog circuits for use in alternative frequency bands. For example, to avoid installing alternative dedicated lines, users often transmit and receive digital communications over the PSTN analog links.

One popular example of digital transmission is Asymmetric Digital Subscriber Line (ADSL). ADSL increases the digital speed of ordinary telephone lines as compared to V.34 (33600 bps) or V.90 (56 Kbps) modems. DSL technologies are either asymmetric or symmetric. Asymmetric DSL, which supports faster downstream than upstream speeds, is best suited for Internet access and video on demand applications. Symmetric DSL supports the same rate for both upstream and downstream traffic.

However, since PSTN local links are intended for and are primarily used for voice-band communications, the frequency response of the lines is generally optimized for signal transmission below about 4 kHz. This tends to make such lines unsuitable for the quality transmission of digital signals. In particular, it is common practice to use a “loading coil,” or “load coil,” in lengthy local telephone loops to improve the frequency response of the lines for voice-band transmissions. The load coils typically have inductance values of about 66 mH or 88 mH. Unfortunately, such load coils generally decimate the quality of high-frequency data transmissions and must be removed to allow the lines to be used for such transmissions. This necessitates a service call each time a coil must be installed (to enable voice band traffic) or removed (to enable high-speed transmissions such as for ADSL). Such service calls are costly and time consuming for the serviced operating company, such as a telephone company.

### SUMMARY OF THE INVENTION

An improved line conditioner is described that conditions a twisted pair line for voice-band traffic while also reducing attenuation of high-speed digital transmissions. Due to the improved qualities of the described line conditioner, the conditioner can be used as a replacement for traditional load coils. When traditional load coils are so replaced, both voice-band and high-speed digital traffic are efficiently propagated along the conditioned twisted pair, used herein as an example of a voice-band transmission medium. An improved build-out replaces traditional capacitor-only build-outs, allowing for capacitive compensation of short transmission lines to match an installed line conditioner while not attenuating high-frequency signals.

The use of the improved line conditioner avoids repeated service calls to install or remove traditional load coils in response to a customer's use of the line for voice-band or digital communications. A voice transmission medium such as a twisted pair can thus be conditioned to pass quality high-frequency digital transmissions such as ADSL, T1, E1, as well as voice band signals such as voice transmissions and V.34, V.90, and fax transmissions.

Additional features and advantages of the invention will be made clear in the following detailed description of illustrative embodiments which is given with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a plot showing the frequency response of a 15,000-foot plain twisted pair 26 AWG transmission line;

FIG. 2 is a plot showing the frequency response of a 15,000-foot plain twisted pair 26 AWG transmission line compared to the frequency response of the same line employing a common load coil;

FIG. 3 is a simplified drawing of a typical transmission line installation scenario;

FIG. 4 is a plot showing the frequency response of a 15,000-foot plain twisted pair 26 AWG transmission line employing a line conditioner according to an embodiment of the invention as compared to the plots of FIGS. 1 and 2;

FIG. 5 is a schematic diagram of the electronic components of a line conditioner according to an embodiment of the invention;

FIG. 6 is a table summarizing installation instructions for placement of a build-out according to an embodiment of the invention with respect to the placement of a line conditioner according to an embodiment of the invention; and

FIG. 7 is a schematic drawing of an improved build-out device according to an embodiment of the invention.

### DETAILED DESCRIPTION OF THE INVENTION

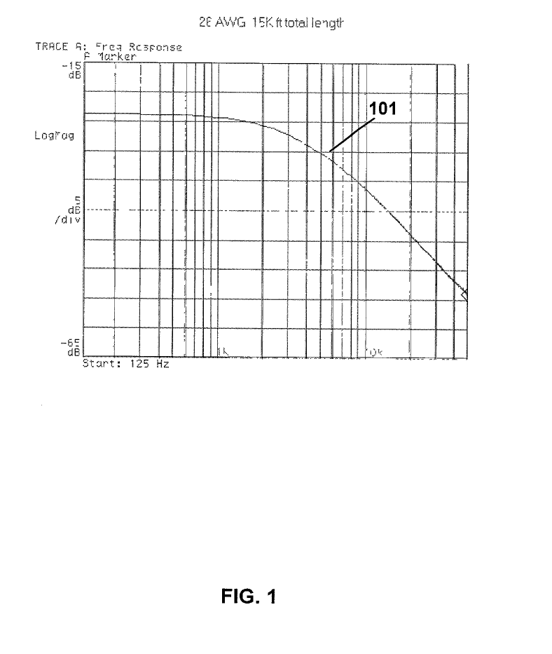

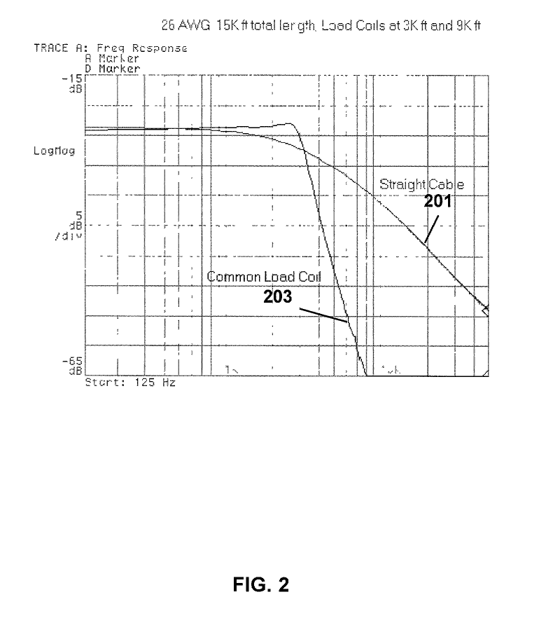

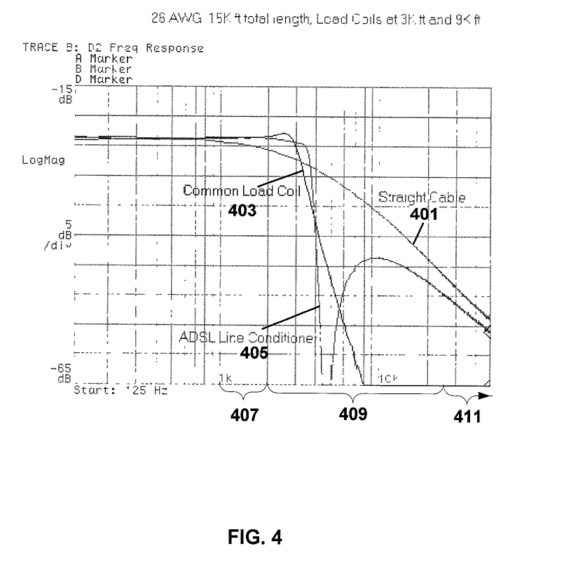

Turning to the drawings, FIG. 1 is plot showing the frequency response of an ordinary twisted pair cable at curve 101. In particular, the data shown in FIGS. 1, 2, and 4 were generated using a 26 AWG transmission line with a length of 15,000 feet and load coils or line conditioners either absent, as with FIG. 1, or placed at 3,000 feet and 9,000 feet as in FIGS. 2 and 4. A twisted pair can be theoretically modeled as an infinite series of infinitesimally small elements, each element including series inductance and resistance along both members of the twisted pair as well as parallel capacitance between the members. It can be seen from curve 101 that the cumulative effect of these elements tends to produce a roll-off in frequency response after about 2 kHz. That means that low-frequency signals, i.e. those in the voice band, are attenuated in the higher frequencies of the range, leading to poor quality speech transmission, while high frequency signals such as ADSL starting at 25 kHz are also somewhat attenuated, but usable.

Even though the bare twisted pair substantially passes voice-band signals, the frequency roll-off at the higher end of the voice-band negatively impacts the quality of voice-band transmissions. To solve this problem, load coils are typically added to the line. The load coil typical adds a series inductance to each pair member, and alters the response of the twisted pair cable to that shown in FIG. 2 at curve 203. It can be seen that the roll-off at the high end of the voice-band has been replaced in curve 203 by a peak in response followed by an extremely rapid decline. This tends to improve the perceived quality of voice-band transmissions, while almost completely attenuating high-frequency signals such as ADSL, making them unusable.

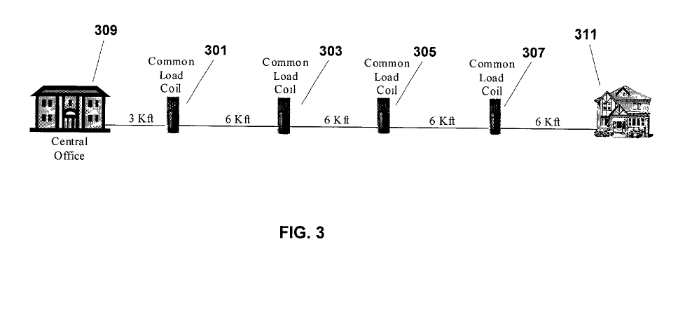

Because the frequency response characteristics of the twisted pair result from an infinite summation of infinitesimal elements over the length of the cable, the frequency response at a location on a cable is a function of the distance of that point from the signal origin, such as the central office. For this reason, load coils can be viewed as compensating a certain length of cable, after which length a load coil is needed. In practice, this typically results in the placement of load coils at approximately every 6,000 feet of cable length, as shown in FIG. 3.

It can be seen that common load coils 301, 303, 305, and 307 are spaced 6,000 feet apart from each other and common load coil 307 is spaced 6,000 feet from the customer premises 311. Typically, in situations where load coils are separated by less than 6000 feet, a build-out capacitor is placed across the tip and ring lines to suppress audible disproportionate response for higher frequencies in the voice band. Normally, the build-out capacitance is calculated to provide 0.083 μF/mile.

The situation shown in FIG. 3 results in a frequency response substantially like that shown in FIG. 2 at curve 203 for a tap placed anywhere along the cable. This means that the line is optimized for voice-band traffic. However, as can be seen by reference to FIG. 2, curve 203, high-frequency traffic such as ADSL will be attenuated to the point of being blocked. Thus, if a subscriber at a particular location along the cable wishes to send or receive high-frequency digital transmissions such as for ADSL service, the load coil associated with that location must be removed. If the subscriber subsequently wishes to use the line for voice-band traffic, the load coil must be reinstalled. This leads to great inefficiencies from repeated service calls, and in addition allows the line to effectively serve only one purpose at a given time for that subscriber.

In order to avoid these inefficiencies and drawbacks inherent in typical practices, it is desirable to have a load coil that operates as a common load coil for voice-band traffic while not attenuating high-frequency digital signals such as ADSL. In accordance with an embodiment of the invention, a line conditioner is provided that has the frequency response characteristics shown by curve 405 in FIG. 4. It can be seen that the signal boost in the high end 407 of the voice band is substantially preserved with respect to that of an ordinary load coil, while additional boost is provided in the high-frequency region 411 to allow transmission of ADSL and other high-frequency digital signals. Thus, a line so conditioned may be used for both voice-band traffic and digital traffic.

An additional benefit of the frequency response shown by curve 405 in FIG. 4 is that it effectively suppresses noise in the “dead zone” 409 between about 3.4 kHz and 25 kHz. This provides a reduction in harmonic cross talk between high-frequency signals, such as ADSL, and voice-band signals.

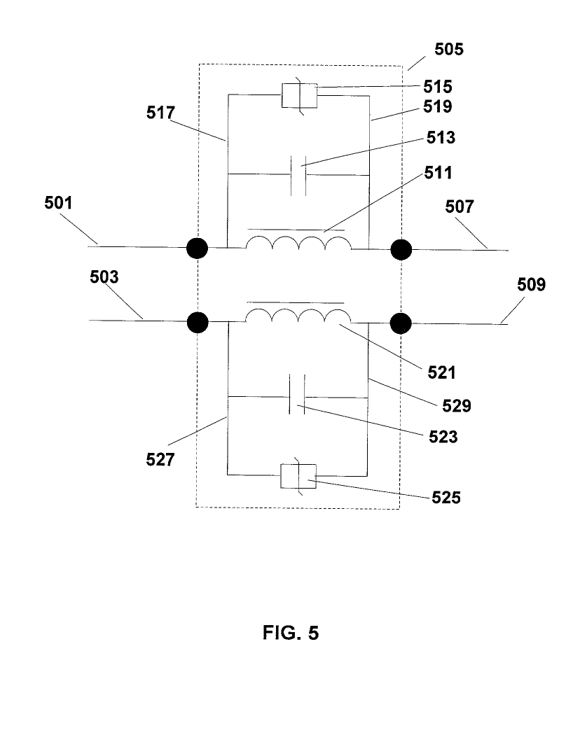

FIG. 5 is a schematic drawing of the improved line conditioner which when installed provides a response as shown in FIG. 4. The upstream tip 501 and ring 503 lines connect to one side of the device 505 while the downstream tip 507 and ring 509 lines connect to the other side. These connections are made by way of externally conductively accessible connectors as with standard load coils. The packaging of the device is adapted to protect the internal components from moisture, salt and other environmental contaminants. The packaging is preferably made to suit the particular environment and mounting technique. For example, in an embodiment, the packaging is configured to allow burial mounting while in another embodiment, the packaging is configured to allow aerial mounting such as on a pole or other structure.

Internally, the upstream tip line 501 connects to a parallel combination of inductor 511, capacitor 513, and transient surge protector 515 via line 517. The downstream tip line 507 connects to the opposite sides of these components in parallel via line 519. Similarly, the upstream ring line 503 connects to a parallel combination of inductor 521, capacitor 523, and transient surge protector 525 via line 527. The downstream tip line 509 connects to the opposite sides of these components in parallel via line 529. The total inductance value of the inductors 511, 521 is preferably 22 mH, but may be any other value that gives the desired frequency response in conjunction with the other internal components of the device 505. The capacitance value of the capacitors 513, 523 is preferably 0.1 μF, with a voltage tolerance of 100V, but also may be any other value that gives the desired frequency response in conjunction with the other internal components of the device 505. Finally, the transient surge protectors 515, 525 preferably allow conduction at approximately 1 00V, or any other desired capacitor voltage tolerance value.

Although those of skill in the art will appreciate that the described transmission line conditioner device for installation on a voice-band transmission medium can be made in a number of ways, one preferred method for producing the device is as follows. Initially, two component groups are created. Each component group comprises an inductor and a capacitor connected in parallel with each other. Subsequently, the component groups are each positioned in series with a respective input connection and a respective output connection, such as wires 517, 519, 527, and 529 in the device of FIG. 5. These input and output connections may be separate conductors that are attached to the component groups or may be integral with one or more of the circuit elements within the component groups. In an embodiment, each component group further comprises a surge protector placed in parallel with each component group prior to packaging. The outward facing open ends of the connections are adapted to be attached to a twisted pair transmission line in the same manner as an ordinary load coil, such that the device as a whole can be placed in series with such a transmission line.

Once the component groups are assembled, the component groups are encased together in a package so that the input connections and output connections are conductively accessible from outside of the package. The encasing material is preferably electrically nonconductive, and may be any of a number of known resins, epoxies and thermoplastics, or other suitable material. Preferably, the package further comprises a stud, extension, or bracket for mounting the device to another surface such as a pole or other structure. The mounting features of the device can be integrally molded of the packaging material, or alternatively are separate pieces securely attached to, or partially embedded in, the packaging material.

The operation of the device 505 leading to the transmission line frequency response characteristics displayed in FIG. 4 will now be described in greater detail. The inductors 511, 521 are responsible, as in an ordinary load coil, for producing a boost in the high end of the voice-band, just prior to a sharp drop-off. In the very low frequency range of the voice band, below about 1 kHz, the capacitors 513, 523 act essentially in an open circuit manner, contributing little to the frequency response. Toward the upper end of the voice band, closer to 3.4 kHz, the capacitor response interacts in a complicated fashion to essentially increase the apparent inductance value of any line conditioner.

At operational voltages the transient surge protectors 515, 525 act essentially as open circuits. Thus, the device 505 when installed provides the frequency characteristics for the twisted pair that are desirable in the voice band to provide transmissions of high quality and low attenuation Over much of the mid-band region 409, such as between approximately 4 kHz and 6 kHz, the frequency response of the conditioned cable comprising the device of FIG. 5 attenuates strongly. In this region, the sharp roll-off typical of a load coil compensated twisted pair predominates, and is enhanced by interaction of the line and line conditioner with capacitors 513, 523. Again, the transient surge protectors 515, 525 are not conductive at operational voltages. Since neither voice-band nor high-frequency digital transmissions such as for ADSL use this frequency range, the attenuation does not detract from quality transmission for both types of signals. Beneficially, the notch in the frequency response aids in suppressing harmonic cross talk between voice-band transmissions and high-frequency transmissions such as those used for ADSL.

In the high frequency range, above approximately 25 kHz, capacitors 513, 523 are substantially conductive, leading to a boost in signals in that frequency range. Since high-frequency transmissions such as ADSL signals use the frequency space above approximately 25 kHz, they are not substantially attenuated by the twisted pair, but rather are passed sufficiently for high-quality transmission and detection. Thus, the conditioned line is usable for both voice-band and high frequency DSL transmissions. Once ordinary load coils are replaced with the line conditioners according to the described embodiments, no further service call is needed to add or remove load coils to or from the line for either voice-band or high frequency DSL traffic.

Since the capacitors are essentially conductive with respect to high frequency signals, a voltage surge, caused for example by a lightning strike, may destroy the capacitors 513, 523 if protection is not provided. In particular, a lightning strike typically creates on the twisted pair cable a 500A signal with rise and fall times on the order of 5 μs. This powerful high-frequency signal could damage or destroy the capacitors 513, 523.

To prevent this from occurring, the line conditioner 505 preferably further comprises transient surge protectors 515, 525 connected across capacitors 513, 523 as described above. In the event that a voltage of greater than approximately 1 00V is applied to the line, the transient surge protectors 515, 525 pass the associated current, sparing the capacitors 513, 523 from damage.

Note that as discussed above, it is common practice to place build-out capacitors between the lines of the twisted line pair in certain installation scenarios. When using the line conditioner as described herein, it is not necessary to have traditional build-outs, and in fact it is desirable to remove such build-outs. Leaving the normal build-outs in the circuit will cause the high-frequency signals to become overly attenuated as the build-out capacitors become essentially conductive.

In an embodiment of the invention, an improved build-out device is used to substitute for traditional build-out capacitors. As with traditional build-outs, the improved build-out device essentially simulates the capacitive response of a length of twisted pair cable. However, since as discussed above the simple capacitors previously used as build-outs will unacceptably attenuate ADSL and other high-frequency signals, the improved build-out device employs a different circuit structure.

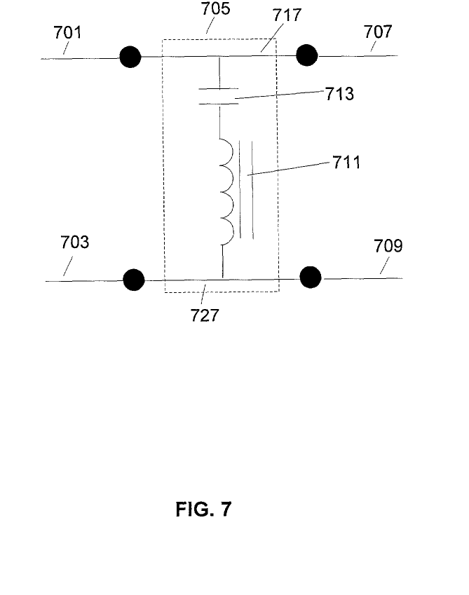

A schematic of the improved build-out device is shown in FIG. 7. An improved build-out 705 is illustrated connected to an upstream tip line 701 and a downstream tip line 707 via line 717 and an upstream ring line 703 and a downstream ring line 709 via line 727. Parallel lines 717 and 727 are bridged by a component group including an inductor 711 and a capacitor 713 in series with each other.

In order to set the behavior of the improved build-out 705, the values of the components in the component group can be varied. In an embodiment, a series of preset behaviors are supported by providing an inductor value of 16.7 mH for inductor 711 while varying the value of the capacitor 713. In an embodiment, the capacitor value is set to 0.047 μF, 0.033 μF, 0.022 μF, and 0.015 μF respectively for build-outs “A,” “B,” “C,” and “D” respectively to be used as indicated in FIG. 7. It is not necessary to place a surge protector in series with the inductor 711 and capacitor 713 since the frequency response of the inductor limits the current passed during a high-frequency pulse such as that caused by a lightning strike. Those of skill in the art will appreciate that other values for the inductor 711 and capacitor 713 may equivalently be used, and that the inductance value may be varied rather than kept constant. Furthermore, the components, as with other component examples herein, may have fixed or variable values.

The improved build-out operates to tune the voice band energies between 2 kHz and 3.4 kHz for missing wire lengths in the same manner as a typical build-out. However, its frequency response across a wider range varies from that of a typical build-out containing only a capacitor. In particular, at high frequencies such as those at and above 25 kHz, a typical build-out will destroy the signal as discussed above. In contrast, the inductor 711 located in the improved build-out illustrated in FIG. 7 blocks high-frequency signals, preventing the capacitor 713 from decimating such signals.

The aforementioned build-out device for installation on a voice-band transmission medium can be manufactured using any one of a number of techniques. One preferred method for producing the device is as follows. Initially, a component group comprising an inductor and a capacitor connected in series with each other is created. The component group is then connected across a parallel lead pair (e.g. lines 717 and 727 in FIG. 7). The lead pair may be separate conductors that are attached to the component group or may be integral with one or more of the circuit elements within the component group. The outward facing open ends of the lead pair are adapted to be conductively attached to a twisted pair transmission line such that the device as a whole can be placed in series with such a transmission line, in the same manner that the line conditioner is attached.

Once the component group and lead lines are assembled, the product is encased in a package so that both ends of each lead pair are conductively accessible from outside of the package as illustrated in FIG. 7. The encasing material is preferably electrically nonconductive and impervious to inclement weather, and may be any of a number of known resins, epoxies and thermoplastics, or other suitable material. Preferably, the package further comprises a stud, extension, or bracket for mounting the device to another surface such as a pole or other structure. The mounting features of the device can be integrally molded of the packaging material, or alternatively are separate pieces securely attached to, or partially embedded in, the packaging material.

The installation and use of the line conditioner and improved build-out according to the described embodiments will now be described in greater detail. The placement of the improved line conditioner, and improved build-outs if used, is similar to the placement for standard components. That is, the locations and connection mechanisms are similar. Thus, with regard to location, the improved line conditioners are preferably located at 3,000 feet from the central office and then every 6,000 feet thereafter. As an example, on a 13,000-foot transmission line, as measured from the central office, line conditioners should be placed at approximately 3,000 feet and 9,000 feet. In this case, the use of the improved build-outs is not required or recommended.

In certain situations, it is not possible to place the line conditioners according to the rules set forth above. For example, a roadway, shopping center, pond, or other natural or man-made structure or condition may prevent placement in the desired location. Thus, referring to the aforementioned example, it could be that a pond is situated at between 7,500 and 10,000 feet from the central office. In this case, it is not practical to place a line conditioner at 9,000 feet. Instead, a line conditioner should be placed prior to the obstruction, such as at 7,000 feet, with an improved build-out installed at that location as well to simulate the missing length of cable (2,000 feet).

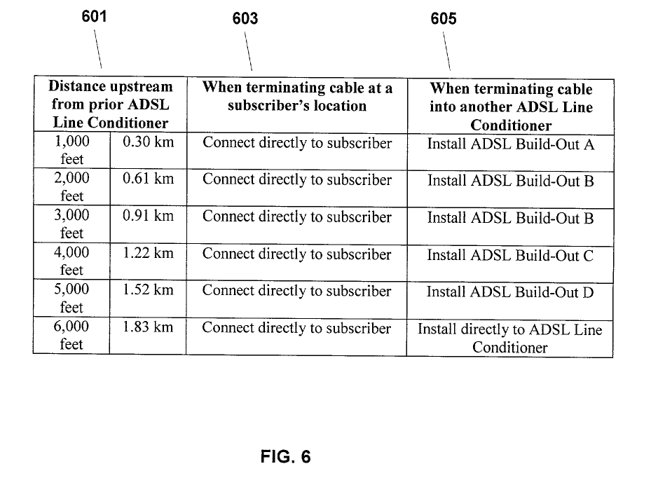

FIG. 6 is a table describing the component connection configuration to be used with respect to several typical installation scenarios. The table has three columns. The first column 601 lists the location of the installation, measured by its distance upstream from a prior line conditioner. The second column 603 indicates the installation method to use when terminating the cable at a subscriber location. Similarly, the third column 605 details the steps to take when terminating the cable into another line conditioner. For example, for a cable terminated at a line conditioner located at 4000 feet upstream from a preceding line conditioner, a build-out C should also be installed. Referring to the discussion above, the build-out C has an inductor of 16.7 mH and a capacitor of 0.022 μF. Distances given in the table of FIG. 6, as well as in other examples, are approximate. Thus, for example, a distance value that differs from a multiple of 1000 may be rounded to the nearest multiple of 1000.

In view of the many possible embodiments to which the principles of this invention may be applied, it should be recognized that the embodiments described herein with respect to the drawing figures are meant to be illustrative only and should not be taken as limiting the scope of the invention. For example, those of skill in the art will recognize that the illustrated embodiments can be modified in arrangement and detail without departing from the spirit of the invention. Additionally, although ADSL signals have been used herein as one example of high-frequency transmissions, those of skill in the art will appreciate that ADSL was mentioned by way of example only, and that any high-frequency transmission system or protocol can benefit from the invention, whether or not it uses the frequency space above 25 kHz as long as it uses a frequency space above the voice band. Therefore, the invention as described herein contemplates all embodiments that may come within the scope of the following claims and equivalents thereof.

We claim:

1. A line conditioner for a bi-directional electrically conductive voice transmission medium usable for both voice-band and high-frequency digital transmission, comprising:
a first component group having a first inductor connected in parallel to a first capacitor, the first component group being connectable in series with a first conductor of the transmission medium; and
a second component group having a second inductor connected in parallel to a second capacitor, the second component group being connectable in series with a second conductor of the transmission medium, whereby when the first and second component groups are connected in series with the first and second conductors respectively, the transmission medium is conditioned to permit the high-quality transmission of voice-band signals and high-frequency digital signals.

2. The line conditioner according to claim 1, wherein the first and second component groups each further comprise first and second surge protectors respectively, wherein the first and second surge protectors are connected in parallel circuit formation with the first and second capacitors respectively.

3. The line conditioner according to claim 1, wherein the bi-directional electrically conductive voice transmission medium comprises a twisted pair cable.

4. The line conditioner according to claim 1, wherein the high frequency digital signals conform to the ADSL protocol.

5. A method of conditioning a voice-band transmission medium comprising the steps of:
placing in series with a first conductor of the transmission medium a component group comprising a first inductor and a first capacitor connected in parallel with the first inductor; and
placing in series with a second conductor of the transmission medium a component group comprising a second inductor and a second capacitor connected in parallel with the second inductor; whereby the transmission medium is conditioned to permit the transmission of high-quality voice-band signals and high-frequency digital signals.

6. The method according to claim 5, further comprising the step of placing in parallel with each of the first and second component groups a first and second surge protector respectively.

7. The method according to claim 5, wherein the transmission medium is a twisted pair cable.

8. The method according to claim 5, wherein the high-frequency digital signals conform to the ADSL protocol.

9. A method of conditioning a voice-band transmission medium comprising the steps of:
locating a load coil device installed on the transmission medium;
connecting a first capacitor in parallel circuit formation with the load coil device on a first conductor of the transmission medium; and
connecting a second capacitor in parallel circuit formation with the load coil device on a second conductor of the transmission medium whereby the transmission medium is conditioned to permit the transmission of high-quality voice-band signals and high-frequency digital signals.

10. The method according to claim 9, further comprising the steps of:
connecting a first surge protector in parallel with the first capacitor: and connecting a second surge protector in parallel with the second capacitor.

11. The method according to claim 9, wherein the voice-band transmission medium is a twisted pair cable.

12. The method according to claim 9, wherein the high-frequency digital signals conform to the ADSL protocol.

13. A method of making a transmission line conditioner device for installation on a voice-band transmission medium comprising the steps of:
creating two component groups, each having in parallel an inductor and a capacitor wherein the component groups are each positioned in series with a respective input connection and a respective output connection; and
encasing the component groups in a package so that the respective input connections and respective output connections are conductively accessible from outside of the package to create a transmission line conditioner device.

14. The method according to claim 13, wherein the component groups each further comprise a surge protector in parallel with the inductor and a capacitor of each component group.

15. The method according to claim 13, wherein the voice-band transmission medium is a twisted pair cable.

16. An improved build-out device for a voice-band transmission medium comprising:
a component group comprising an inductor and a capacitor connected in series circuit formation with one another;
a first lead line, the first lead line being connectable in series with a first conductor of the transmission medium; and
a second lead line, the second lead line being connectable in series with a second conductor of the transmission medium, wherein the first and second lead lines are related in parallel circuit formation and the component group is connected across the first and second lead lines, whereby when the first and second lead lines are connected in series with the first and second conductors respectively, the transmission medium is conditioned to permit the high-quality transmission of voice-band signals and high-frequency digital signals.

17. The improved build-out device according to claim 16, wherein the bi-directional electrically conductive voice transmission medium comprises a twisted pair cable.

18. The improved build-out device according to claim 16, wherein the high frequency digital signals conform to the ADSL protocol.

19. A method of conditioning a voice-band transmission medium comprising the steps of:
placing a first end of a component group having two ends in conductive contact with a first conductor of the transmission medium, wherein the component group comprises an inductor and a capacitor connected in series circuit formation with respect to one another; and
placing a second end of the component group in conductive contact with a second conductor of the transmission medium which is in parallel circuit formation to the first conductor, whereby the component group is connected across the parallel conductors, and whereby the transmission medium is conditioned to permit the transmission of high-quality voice-band signals and high-frequency digital signals.

20. The method according to claim 19, wherein the voice-band transmission medium is a twisted pair cable.

21. The method according to claim 19, wherein the high-frequency digital signals conform to the ADSL protocol.

22. A method of making an improved transmission line build-out device for installation on a voice-band transmission medium comprising the steps of:
creating a component group having an inductor and a capacitor connected in series circuit formation with respect to each other, wherein the component group is conductively connected at one end to a first lead line having an input connection and an output connection and conductively connected at a second end to a second lead line in parallel circuit formation with the first lead line, the second lead line having an input connection and an output connection; and
encasing the component group in a package so that the respective input connections and respective output connections of the first and second lead lines are conductively accessible from outside of the package to create an improved transmission line build-out device.
